(19) United States
(12) Patent Application Publication
(10) Pub. No.: US 2026/0064049 A1
(43) Pub. Date: Mar. 5, 2026

(54) FIXING DEVICE AND IMAGE FORMING APPARATUS

(71) Applicant: KYOCERA Document Solutions Inc., Osaka (JP)

(72) Inventors: Akihiro KONDO, Osaka (JP); Ryohei TOKUNAGA, Osaka (JP); Hiroki KAWASAKI, Osaka (JP); Shunsaku FUJII, Osaka (JP); Kenichi KASAMA, Osaka (JP); Yuto MASAOKA, Osaka (JP); Takashi MIYAKE, Osaka (JP)

(73) Assignee: KYOCERA Document Solutions Inc., Osaka (JP)

(21) Appl. No.: 19/305,317

(22) Filed: Aug. 20, 2025

(30) Foreign Application Priority Data
Aug. 28, 2024 (JP) 2024-146608

(51) Int. Cl. G03G 15/20

(52) U.S. Cl. CPC G03G 15/2017; G03G 15/2064; G03G 2215/2035

(57) ABSTRACT

A fixing device includes a fixing belt, a pressure member, a heater, a heat equalizing member, a support member, and a positioning structure. The support member comes into contact with one surface of the heat equalizing member on an opposite side to the heater, and supports the heat equalizing member. The positioning structure positions the heat equalizing member with respect to the support member. The positioning structure includes a positioning hole, a positioning recess, and a positioning member. The positioning hole penetrates in a thickness direction a center region of the heat equalizing member in the axial direction. The positioning recess is recessed in a center region of the support member in the axial direction, where coincides with the positioning hole. The positioning member is fitted into a positioning space formed by the positioning hole and the positioning recess while in contact with one surface of the heater.

### INCORPORATION BY REFERENCE

This application is based on and claims the benefit of priority from Japanese patent application No.2024-146608 Aug. 28, 2024, which is incorporated by reference in its entirety.

### TECHNICAL FIELD

The present disclosure relates to a fixing device which fixes a toner image on a medium and an image forming apparatus.

### BACKGROUND

There is known an image heating device (fixing device) which heats toner on a recording material while passing the recording material through a fixing nip between an endless belt and a rotating body. The image heating device includes a heating member in contact with the inner peripheral surface of the endless belt, a holding member holding the heating member, and a heat conduction member held between the heating member and the holding member. The heat conduction member is formed in a rectangular shape and is engaged with the holding member via a regulating part formed on one side in the longitudinal direction. The regulating part regulates movement of the heat conduction member in the longitudinal direction with respect to the holding member.

However, in the image heating device (fixing device) described above, the heat of the heating member is also transmitted to the heat conduction member, and the heat conduction member thermally expands (extends) mainly to the other side in the longitudinal direction which is opposite to the regulating part. Then, the heat conduction member moves (shifts) to the other side in the longitudinal direction with respect to the heating member, and the temperature distribution of the heating member (belt) is biased. As a result, the toner on the recording material cannot be properly heated, resulting in the occurrence of image defects.

### SUMMARY

A fixing device according to the present disclosure includes a fixing belt, a pressure member, a heater, a heat equalizing member, a support member, and a positioning structure. The fixing belt is formed in a cylindrical shape and heats toner on a medium while rotating around an axis. The pressure member forms a pressure region between the fixing belt and the pressure member, and pressurizes the toner on the medium passing through the pressure region while rotating around an axis. The heater extends in an axial direction of the axis of the fixing belt, comes into contact with an inner surface of the fixing belt in the pressure region, and heats the fixing belt. The heat equalizing member extends in the axial direction so as to be less than or equal to a dimension of the heater in the axial direction, comes into contact with one surface of the heater on an opposite side to the fixing belt, absorbs heat emitted from the heater and moves it in the axial direction. The support member comes into contact with one surface of the heat equalizing member on an opposite side to the heater, and supports the heat equalizing member. The positioning structure positions the heat equalizing member with respect to the support member. The positioning structure includes a positioning hole, a positioning recess, and a positioning member. The positioning hole penetrates in a thickness direction a center region of the heat equalizing member in the axial direction. The positioning recess is recessed in the thickness direction in a center region of the support member in the axial direction, where coincides with the positioning hole. The positioning member is fitted into a positioning space formed by the positioning hole and the positioning recess while in contact with one surface of the heater.

An image forming apparatus according to the present disclosure includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (side view) showing an internal structure of an image forming apparatus according to one embodiment of the present disclosure.

FIG. 2 is a perspective view showing a fixing device according to the embodiment of the present disclosure.

FIG. 3 is a cross-sectional view taken along the line III-III of FIG. 2.

FIG. 4 is a bottom view showing a heater of the fixing device according to the embodiment of the present disclosure.

FIG. 5 is a plan view showing the heater, a heat equalizing member and a positioning structure of the fixing device according to the embodiment of the present disclosure.

FIG. 6 is a cross-sectional view taken along the line VI-VI of FIG. 5.

FIG. 7 is a cross-sectional view showing the heater, the heat equalizing member, and the positioning structure of the fixing device according to a first modified example of the embodiment of the present disclosure.

FIG. 8 is a plan view showing the heater, the heat equalizing member, and the positioning structure of the fixing device according to a second modified example of the embodiment of the present disclosure.

FIG. 9 is a cross-sectional view taken along the line IX-IX of FIG. 8.

FIG. 10 is a plan view showing the heater, the equalizing member, and the positioning structure of the fixing device according to a third modified example of the embodiment of the present disclosure.

### DETAILED DESCRIPTION

Hereinafter, with reference to the attached drawings, an embodiment of the present disclosure will be described. Fr, Rr, L, R, U and D shown in the drawings indicate front, rear, left, right, upper and lower. The front-and-rear direction, the left-and-right direction (axial direction), and the upper-and-lower direction are orthogonal to each other. Although terms indicating direction and position are used herein, these terms are used for convenience of explanation and are not intended to limit the scope of the disclosure. The terms “upstream”, “downstream”, and the related terms refer to “upstream”, “downstream” in the conveyance direction of the paper P (medium), and the related concepts. In each of the figures, the dimensions and angles of the members are not accurate and are schematized for the sake of illustration.

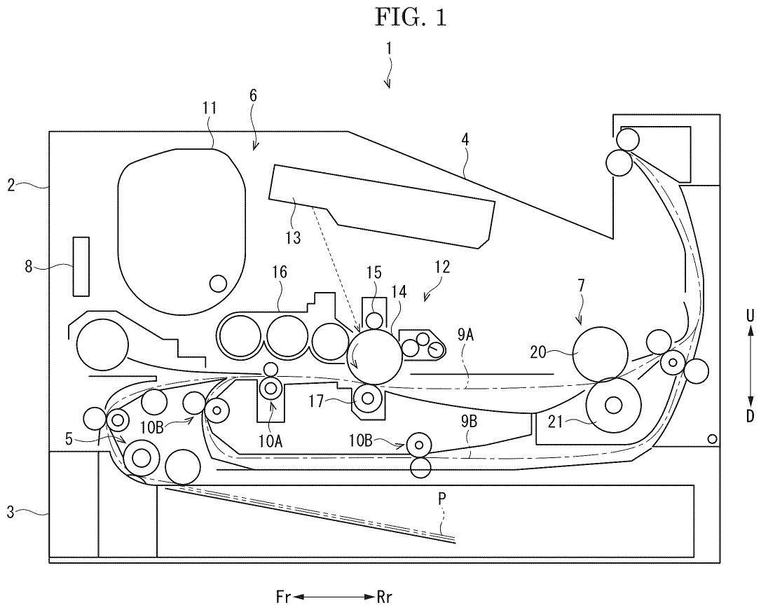

With reference to FIG. 1, an image forming apparatus 1 according to the present embodiment will be described. FIG. 1 is a schematic view (side view) showing the image forming apparatus 1.

The image forming apparatus 1 is an electrophotographic printer. The image forming apparatus 1 includes with an apparatus main body 2 constituting a substantially rectangular parallelepiped appearance. A paper feeding cassette 3 which stored a paper P (medium), for example, is detachably provided at the lower portion of the apparatus main body 2. A paper discharge tray 4 is provided on the upper surface of the apparatus main body 2. The paper P as an example of the medium is not limited to a paper but may be a resin sheet or the like.

The image forming apparatus 1 includes a paper feeding device 5, an image forming device 6, and a fixing device 7. The paper feeding device 5 is provided at the upstream end of a conveyance path 9A extending from the paper feeding cassette 3 to the paper discharge tray 4, and feeds the papers P stored in the paper feeding cassette 3 to the conveyance path 9A one by one. The image forming device 6 is provided in the intermediate portion of the conveyance path 9A and forms a toner image on the conveyed paper P. The fixing device 7 is provided on the downstream portion of the conveyance path 9A and thermally fixes the toner image to the paper P.

On the conveyance path 9A, a pair of registration rollers 10 which temporarily blocks the conveyed paper P and corrects the skew of the paper P (skew correction) is provided. An inversion conveyance path 9B is provided below the conveyance path 9A, which branches at the downstream portion of the conveyance path 9A and merges with the upstream portion of the conveyance path 9A. On the inversion conveyance path 9B, a plurality of pairs of conveying rollers 10B for conveying the paper P are provided.

The image forming device 6 includes a toner container 11, a drum unit 12, and an optical scanner 13. The toner container 11 is disposed in the front upper portion of the apparatus main body 2, and contains, for example, black toner (developer). The drum unit 12 includes a photosensitive drum 14, a charging device 15, a developing device 16, and a transfer roller 17. The photosensitive drum 14 is formed in a substantially cylindrical shape, and is driven to be rotated around an axis by a motor (not shown). The charging device 15, the developing device 16 and the transfer roller 17 are arranged around the photosensitive drum 14 in the order of the image forming process. The transfer roller 17 is in contact with the photosensitive drum 14 from the lower side to form a transfer nip. The optical scanner 13 is provided above the photosensitive drum 14, and emits scanning light toward the surface of the photosensitive drum 14.

The image forming apparatus 1 is provided with a control device 8 for controlling the entire apparatus. The control device 8 may be configured by a processor or a logic circuit (hardware) formed in an integrated circuit or the like. In the case of the processor, the processor reads and executes programs stored in a memory to performs various processes.

[Image Forming Process] The control device 8 for controlling the image forming apparatus 1 performs an image forming process based on image data input from an external terminal as follows.

The charging device 15 charges the surface of the photosensitive drum 14, and the optical scanner 13 emits scanning light based on the image data to form an electrostatic latent image on the photosensitive drum 14. The developing device 16 develops the electrostatic latent image on the photosensitive drum 14 into a toner image using the toner replenished from the toner container 11. The paper feeding device 5 feeds the paper P one by one from the paper feeding cassette 3 to the conveyance path 9A. The paper P is conveyed along the conveyance path 9A, after the skew is corrected by the pair of registration rollers 10A, the paper P enters the transfer nip. The transfer roller 17 transfers the toner image on the photosensitive drum 14 to the surface of the paper P passing through the transfer nip. The fixing device 7 thermally fixes the toner image to the paper P. In the case of single-sided printing, the paper P which has passed through the fixing device 7 is discharged to the paper discharge tray 4.

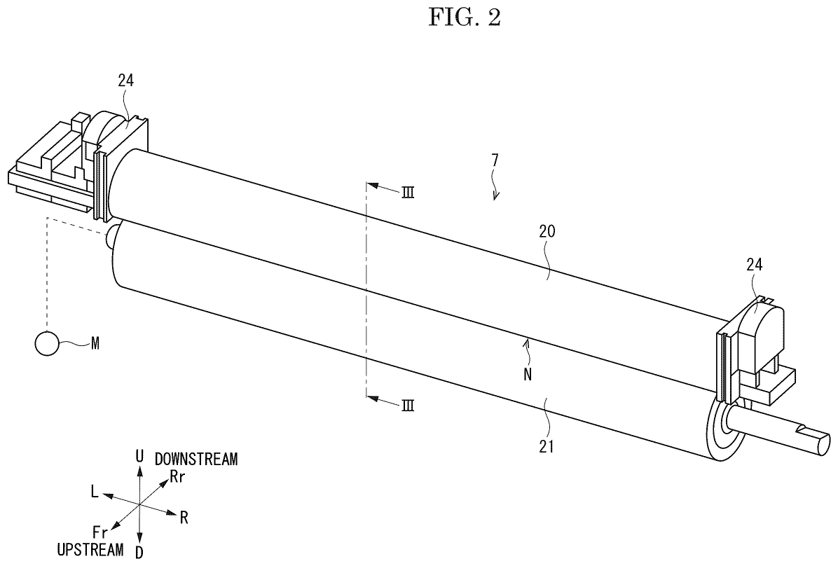

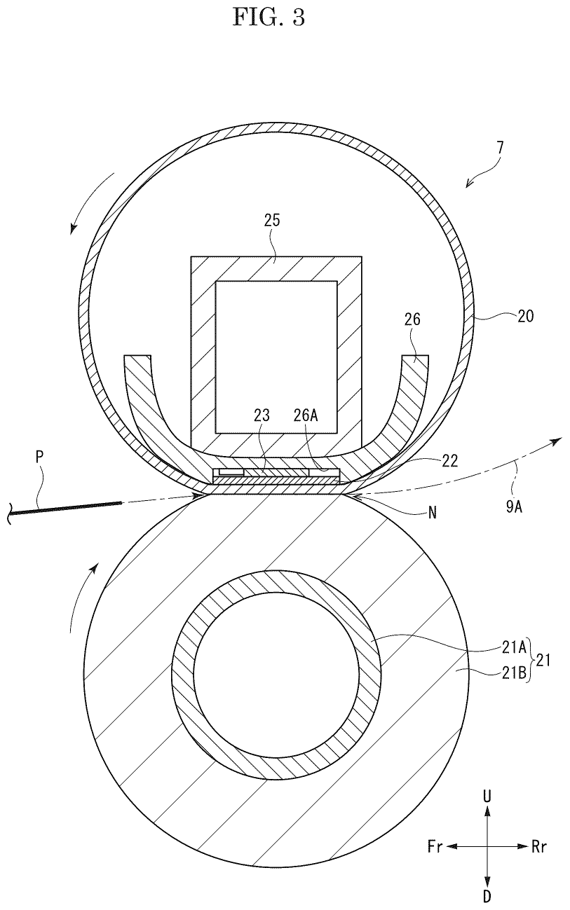

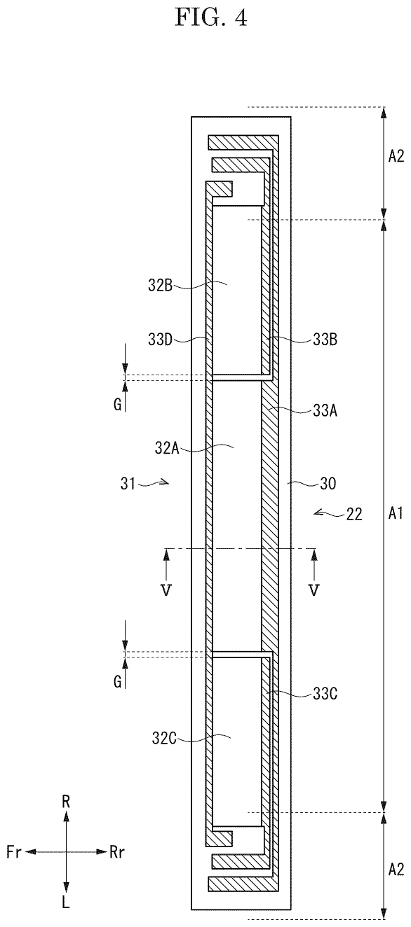

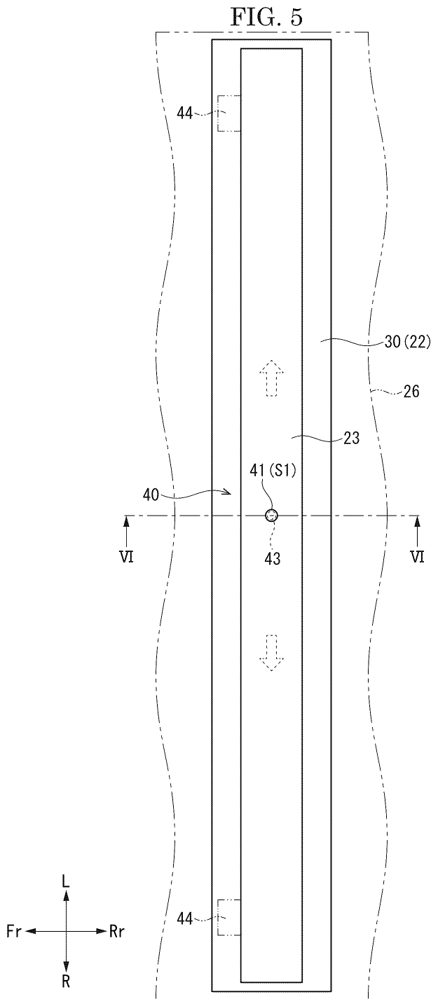

In the case of double-sided printing, the paper P which has passed through the fixing device 7 is switched back at the downstream end of the conveyance path 9A, and sent to the inversion conveyance path 9B. The paper P is conveyed by the pair of conveying rollers 10B, returned from the inversion conveyance path 9B to the conveyance path 9A again, and sent to the transfer nip after the skew correction by the pair of registration rollers 10A. Thereafter, the toner image is transferred to the paper P, and thermally fixed, and the double-sided printed paper P is discharged to the paper discharge tray 4.

[Fixing Device] Next, the fixing device 7 will be described with reference to FIG. 2 to FIG. 6. FIG. 2 is a perspective view showing the fixing device 7. FIG. 3 is a cross-sectional view taken along the line III-III of FIG. 2. FIG. 4 is a bottom view showing a heater 22. FIG. 5 is a plan view showing the heater 22, a heat equalizing member 23, and a positioning structure 40.

As shown in FIG. 2 and FIG. 3, the fixing device 7 includes a fixing belt 20, a pressure roller 21, a heater 22, and a heat equalizing member 23. The fixing belt 20 and the pressure roller 21 are supported by a frame (not shown), and the frame is fixed to the apparatus main body 2.

<Fixing Belt> The fixing belt 20 is an endless belt formed in a substantially cylindrical shape elongated in the left-and-right direction (axial direction). The fixing belt 20 is made of material having heat resistance and flexibility (polymer resin or metal, or combination of polymer resin and metal). A pair of holding members 24 (see FIG. 2) are inserted into both right and left ends of the fixing belt 20. The pair of holding members 24 guide the fixing belt 20 rotatably around an axis while holding the fixing belt in a substantially cylindrical shape. The fixing belt 20 is supported by the frame via the pair of holding members 24 (not shown).

As shown in FIG. 3, an erection member 25 and a support member 26 are provided in a space surrounded by the fixing belt 20. The erection member 25 is made of, for example, metallic material such as stainless steel, and formed in a substantially rectangular cylindrical shape elongated in the left-and-right direction (axial direction), and is erected between the pair of holding members 24. The support member 26 is fixed to the lower portion of the erection member 25. The support member 26 is made, for example, of synthetic resin having heat resistance and wear resistance, and formed in a substantially semi-cylindrical shape elongated in the left-and-right direction. The support member 26 is curved along the inner surface of the fixing belt 20 and is in contact with the lower portion (the portion on the side of a pressure region N) of the inner surface of the fixing belt 20. A fitting portion 26A into which the heater 22 is fitted is recessed in the lower portion of the support member 26.

<Pressure Roller> As shown in FIG. 2 and FIG. 3, the pressure roller 21 as an example of the pressure member is formed in a substantially cylindrical shape elongated in the left-and-right direction. The pressure roller 21 has a metal core 21A and an elastic layer 21B such as a silicon sponge laminated on the outer peripheral surface of the metal core 21A (see FIG. 3). A drive motor M is connected to the left end of the metal core 21A via a gear train (not shown) (see FIG. 2). The pressure roller 21 comes into contact with the fixing belt 20 from the lower side and forms a pressure region N between the fixing belt 20 and the pressure roller 21. When the paper P passes through the pressure region N, the toner image is fixed on the paper P. The pressure region N refers to from an upstream position where the pressure is 0 Pa to a downstream position where the pressure is 0 Pa again via a position where the pressure acts.

The paper P is conveyed so that the center of the width in the left-and-right direction substantially coincides with the center of the pressure region N in the left-and-right direction (axial direction). For this reason, the fixing belt 20 (or the pressure region N) is provided with a passing region A1 which is the center region in the axial direction and is in contact with the paper P, and non-passing region A2 which are the side end regions in the axial direction and are not in contact with the paper P (see FIG. 4). The paper P to be conveyed always comes into contact with the vicinity of the center region in the axial direction of the passing region A1, regardless of the size (dimension in the left-and-right direction) of the paper P. On the other hand, the paper P of a normal size (for example, A4 size) comes into contact with the regions on both sides of the passing region A1 in the axial direction, but the paper P of a small size (for example, A5 size, B5 size, or others) does not come into contact with the regions on both sides of the passing region.

<Heater> As shown in FIG. 3 and FIG. 4, the heater 22 extends in the left-and-right direction (axial direction) of the fixing belt 20, and is fitted into the fitting portion 26A of the support member 26. The heater 22 comes into contact with the inner surface of the fixing belt 20 facing the pressure region N, and heats the fixing belt 20. As shown in FIG. 4, the heater 22 includes a substrate 30 and a heat generating part 31.

The substrate 30 is made of, for example, insulator (electrical insulating material) such as ceramic, and is formed in a substantially rectangular plate shape elongated in the left-and-right direction (axial direction). The axial dimension of the substrate 30 (the heater 22) is set equal to or smaller than the axial dimension of the fixing belt 20. The heat generating part 31 is provided on the lower surface of the substrate 30, which is the inner surface side of the fixing belt 20. The heat generating part 31 includes three resistance heating elements 32A to 32C arranged in a row with gaps G in the axial direction. In this specification, when the three resistance heating elements 32A to 32C are commonly described, only arithmetic numerals are attached to the reference numerals. The gap G is set to an insulation distance (creepage distance) capable of preventing creeping discharge between the adjacent resistance heating elements 32.

The resistance heating element 32 is made of metal material having a high electrical resistance value, and formed in a substantially rectangular shape. The entire heat generating part 31 is shorter in length than the total length of the fixing belt 20 in the left-and-right direction (axial direction) and longer in the axial direction than the passing region A1 of the fixing belt 20. That is, the portions on both sides of the resistance heating elements 32B, 32C in the axial direction, which are located on both side in the axial direction, face the non-passing regions A2 of the fixing belt 20. The resistance heating elements 32A located at the center in the axial direction correspond to the width of the small-size paper P in the left-and-right direction, and all resistance heating elements 32A to 32C correspond to the width of the no-mal-size paper P in the left-and-right direction.

On the lower surface of the substrate 30, three individual electrodes 33A to 33C and a common electrode 33D are formed. The three individual electrodes 33A to 33C and the common electrode 33D are made of, for example, metal material having an electrical resistance lower than that of the resistance heating element 32. In the present specification, when the three individual electrodes 33A to 33C and the common electrode 33D are commonly described, only arithmetic numerals are attached to the reference numerals.

The individual electrode 33A is connected to the downstream end (rear end) of the first resistance heating element 32A which is located at the center in the axial direction, and the other individual electrodes 33B, 33C are connected to the downstream ends of the resistance heating elements 32B, 32C. The common electrode 333D is connected to the upstream ends (front ends) of all the resistance heating elements 32A to 32C. The electrodes 33 extend toward both sides in the axial direction of the heat generating part 31 from portions connected to the heat generating part 31, respectively. The electrodes 33 are electrically connected to a device (not shown) such as a power source on both sides of the substrate 30 in the axial direction.

The heat generating part 31 and the electrode 33 are covered with a coating layer (not shown). The heater 22 is fitted into the fitting portion 26A of the support member 26 and brings the coating layer into contact with the inner surface of the fixing belt 20. When the heater 22 receives the fixing belt 20 pressed against the pressure roller 21, the pressure region N is formed at a contact portion between the fixing belt 20 and the pressure roller 21. The fixing device 7 is provided with a temperature detection part (not shown) for detecting the temperature of the heater 22. The heater 22, the drive motor M, and the temperature detection part are electrically connected to the control device 8, a power supply (not shown), and the others. The control device 8 appropriately controls the power source, the heater 22, and the others.

<Heat Equalizing Member> Since the fixing belt 20 has a smaller thermal capacity than rollers, the fixing device 7 employing the fixing belt 20 has the advantage that the time required for warm-up is shorter. However, for example, when a small size paper P is continuously fixed, excessive temperature rise is suppressed in most of the passing region A1 of the fixing belt 20 because the paper P (toner image) takes away heat, but the both end portions of the passing region A1 in the axial direction and the non-passing region A2 where the paper P does not pass may become excessively hot. Therefore, in the fixing device 7 of this embodiment, the heat equalizing member 23 is provided on the heater 22 in order to suppress the excessive temperature rise in the non-passing region A2 and the others of the fixing belt 20.

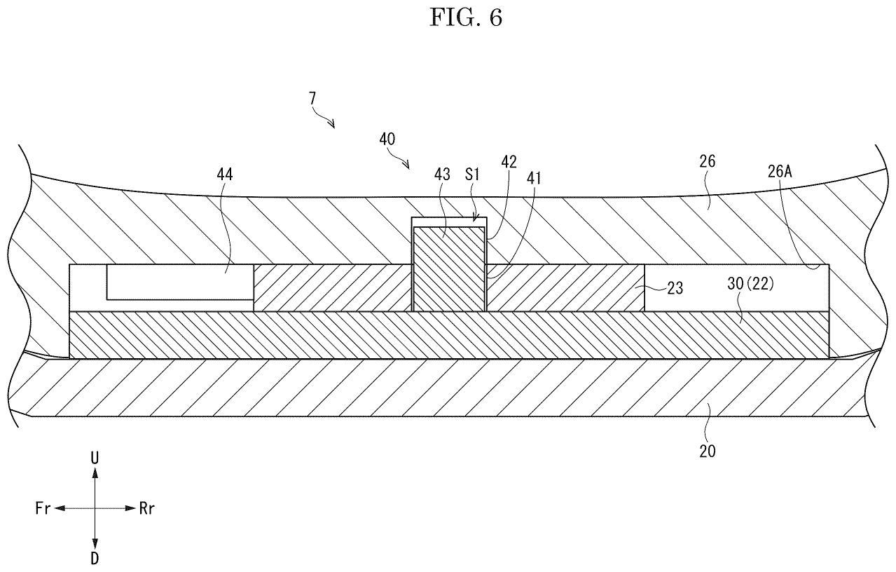

The heat equalizing member 23 is made of, for example, metal material such as aluminum alloy, and formed in a substantially rectangular plate shape. As shown in FIG. 5, the heat equalizing member 23 extends in the axial direction so that it is less than or equal to the dimension of the heater 22 in the left-and-right direction (axial direction). As shown in FIG. 5 and FIG. 6, the heat equalizing member 23 is provided on (in contact with) the upper surface (one side surface) of the heater 22 (the substrate 30) that is opposite to the fixing belt 20 (the pressure area N). The support member 26 described above is in contact with the upper surface (one side surface) of the heat equalizing member 23, which is the opposite side of the heater 22, and supports the heat equalizing member 23 (see FIG. 3).

The heat equalizing member 23 is in contact with the substrate 30 of the heater 22 with a lubricant (not shown), such as a silicon grease. The lubricant adheres the heat equalizing member 23 to the substrate 30 and also facilitates the transfer of heat from the heater 22 to the heat equalizing member 23. The heat equalizing member 23 is positioned to cover the three resistance heating elements 32A to 32C, and absorbs the heat emitted from the heater 22 and moves it in the axial direction. That is, the heat equalizing member 23 equalizes the temperature of the heater 22 over the axial direction. As a result, the temperature of the fixing belt 20 is also equalized in the axial direction, and excessive temperature rise of the non-passing region A2 is suppressed. In this specification, the term “equalizing” does not refer only to the state of being completely constant, but also to the meaning of allowing a slight error.

[Fixing Process] Here, the operation (fixing process) of the fixing device 7 will be described. The control device 8 controls the drive motor M to rotate the pressure roller 21 around the axis. The fixing belt 20 rotates in accordance with the pressure roller 21 (see the arrow in FIG. 3). The control device 8 receives a detection signal from the temperature detection part and controls the heater 22 (or the power source) so as to maintain a preset target temperature. The heater 22 (the heat generating part 31) generates heat by being powered, and heat the fixing belt 20 (pressure region N).

At this time, the control device 8 changes the three resistance heating elements 32A to 32C for heating (being powered) according to a size of the paper P. For example, when the paper P of a normal size passes through the pressure region N, the control device 8 executes control for heating all the resistance heating elements 32A to 32C. When the paper P of a small size passes through the pressure region N, the control device 8 executes control for heating one resistance heating element 32A. Thus, only a necessary area of the fixing belt 20 (pressure region N) can be heated in accordance with the size of the paper P. As a result, the power used can be kept to a minimum. It is also possible to suppress excessive temperature rise at both the axial end portions of the fixing belt 20.

When the temperature of the fixing belt 20 (heater 22) reaches the target temperature, the control device 8 starts the image forming process already described. The paper P on which the toner image is transferred enters the pressure region N. The fixing belt 20 heats the toner (toner image) on the paper P passing through the pressure region N while rotating around the axis. The pressure roller 21 pressurizes the toner on the paper P passing through the pressure region N while rotating around the axis. Then, the toner image is fixed to the paper P, and a fixed image is formed on the paper P. The paper P on which the image is fixed is discharged to the paper discharge tray 4.

[Positioning Structure] By the way, the heat equalizing member 23 receives heat from the heater 22 and expands mainly in the axial direction (longitudinal direction). The support member 26 also receives heat and expands, but the support member 26, which is made of synthetic resin, does not expand as much as the heat equalizing member 23, which is made of metal, because it does not conduct heat as well. Considering the difference in thermal expansion coefficients between the support member 26 and the heat equalizing member 23, the support member 26 must support the heat equalizing member 23 so that the thermal expansion of the heat equalizing member 23 is allowed. Therefore, the fixing device 7 is provided with the positioning structure 40 which positions the heat equalizing member 23 with respect to the support member 26 while allowing the thermal expansion of the heat equalizing member 23. By being positioned on the support member 26, the heat equalizing member 23 is also positioned with respect to the heater 22. The term “positioning” does not mean that it is required to be fixed, but rather that it is arranged within a desired range.

With reference to FIG. 5 and FIG. 6, the positioning structure 40 will be described. FIG. 6 is a cross-sectional view taken along the line VI-VI of FIG. 5.

As shown in FIG. 5 and FIG. 6, the positioning structure 40 includes a positioning hole 41 formed in the heat equalizing member 23, a positioning recess 42 formed in the support member 26, a positioning member 43 which determines the position of the heat equalizing member 23 in the axial direction (long side direction), and a plurality of rotation regulation parts 44 which determine the position of the heat equalizing member 23 in the conveyance direction (short side direction).

<Positioning Hole> The positioning hole 41 penetrates in the thickness direction the center region of the heat equalizing member 23 in the axial direction. Specifically, the positioning hole 41 is a round hole having a circular opening when the heat equalizing member 23 is viewed from the plane (or bottom). The positioning hole 41 is formed at the center in the axial direction (long side direction) and at the center of the heat equalizing member 23 in the conveyance direction (short side direction). In other words, the positioning hole 41 is formed at the center of the heat equalizing member 23 as viewed from the plane (or bottom).

<Positioning Recess> The positioning recess 42 is recessed in the thickness direction at the center region of the support member 26 in the axial direction, where coincides with the positioning hole 41. Specifically, the positioning recess 42 is a round hole with a circular upper surface when the support member 26 is viewed from the bottom. An inner diameter of the positioning recess 42 is substantially equal to the inner diameter of the positioning hole 41. The positioning recess 42 is formed at the center of the support member 26 in the axial direction (long direction) and at the center in the conveyance direction (short side direction). The positioning recess 42 is recessed from the lower surface of the support member 26 to near the center in the thickness direction.

The heat equalizing member 23 is held between the heater 22 (the upper surface of the substrate 30) and the support member 26 (the upper surface of the fitting portion 26A). The heat equalizing member 23 and the support member 26 are stacked with the positioning hole 41 and the positioning recess 42 aligned. The positioning holes 41 and the positioning recess 42 form a positioning space S1 which houses the positioning member 43. In detail, the positioning space S1 is substantially a cylindrical space surrounded by the upper surface of the heater 22 (the substrate 30), the inner peripheral surface of the positioning hole 41, the inner peripheral surface and the upper surface of the positioning recesses 42.

<Positioning Member> The positioning member 43 is made of metallic material such as, for example, aluminum alloy, and formed in an approximately cylindrical shape. An outer diameter of the positioning member 43 is set very slightly smaller than an inner diameter of the positioning hole 41. A height of the positioning member 43 is set slightly smaller than the sum of the thickness of the heat equalizing member 23 (height of the positioning hole 41) and the height (depth) of the positioning recess 42.

The positioning member 43 is fitted into the positioning space S1 in contact with the upper surface (one surface) of the heater 22 (substrate 30). The bottom surface of the positioning member 43 is in close contact with the upper surface of the heater 22, and the upper surface of the positioning member 43 faces the upper surface of the positioning recess 42 with a small gap. The outer peripheral surface of the positioning member 43 faces the inner peripheral surfaces of the positioning hole 41 and the positioning recess 42 with a very small gap. That is, the positioning member 43 is fitted into the positioning space S1 with no rattling in the radial direction (the front-and-rear direction and the left-and-right direction).

<Rotational Regulation Part> A plurality (for example, two) of rotation regulation parts 44 are integrally molded with the support member 26 and protrude from the support member 26 toward the heater 22. Specifically, the two rotation regulation parts 44 are provided on the upstream side (front side) of the support member 26 in the conveyance direction and on both sides of the support member 26 in the axial direction (left-and-right direction) (see FIG. 5). Each rotation regulation part 44 is formed in an approximately rectangular shape, and protrudes downwardly from the upper surface of the fitting portion 26A (see FIG. 6). The lower end surface of each rotation regulation part 44 does not come into contact with the heater 22, but faces the upper surface of the heater 22 (substrate 30) with a small gap. The two rotation regulation parts 44 come into contact with the upstream side surface of the heat equalizing member 23 in the conveyance direction and regulate the rotation of the heat equalizing member 23 around the positioning member 43.

The positioning member 43 is fitted into the positioning space S1 and the two rotation regulation parts 44 come into contact with the heat equalizing member 23, so that the heat equalizing member 23 is positioned with respect to the support member 26. The heat equalizing member 23 is also positioned with respect to the heater 22 by being positioned to the support member 26.

As already explained, the support member 26 is made of synthetic resin, and the heat equalizing member 23 and the positioning member 43 are made of metal. Since the positioning member 43 is housed in the positioning space S1 and also functions as a part of the heat equalizing member 23, in this embodiment, the positioning member 43 is made of the same material as the heat equalizing member 23. In this embodiment, the thermal conductivity (λ1) of the heat equalizing member 23, the thermal conductivity (λ2) of the support member 26, and the thermal conductivity (λ3) of the positioning member 43 are in the relationship (λ3)=(λ1)>(λ2). The thermal conductivity (λ3) of the positioning member 43 may be larger than the thermal conductivity (λ1) of the heat equalizing member 23. That is, the thermal conductivities of the heat equalizing member 23, the support member 26, and the positioning member 43 may be in a relationship (λ3)≥(λ1)>(λ2). Although the positioning member 43 is metallic material, it may also be a thermally anisotropic graphite or the like.

[Operation of Positioning Structure] An operation of the positioning structure 40 will be described. When the fixing device 7 performs the fixing process, the heat equalizing member 23 and the support member 26 receive heat from the heater 22 and expand thermally. Since the heat equalizing member 23 transfers heat more easily than the support member 26, the heat equalizing member 23 mainly expands thermally along the axial direction (its axial dimension increases). The positioning member 43 is provided at the center of the heat equalizing member 23, and the heat equalizing member 23 is positioned to the support member 26 via the positioning member 43. Therefore, the heat equalizing member 23 expands approximately equally in both directions of the axial direction (left-and-right direction) around the positioning member 43 (see the dashed arrows shown in FIG. 5). That is, the heat equalizing member 23 is formed in a line-symmetric shape with respect to the positioning member 43 even in the state of thermal expansion.

According to the fixing device 7 of this embodiment described above, the heat equalizing member 23 can transfer the heat emitted from the heater 22 uniformly throughout the entire axial direction, thereby suppressing uneven temperature distribution in the fixing belt 20. This allows the toner on the medium to be properly heated, thereby suppressing the occurrence of image defects. In addition, since the positioning member 43 fitted in the positioning space S1 is in contact with the heater 22, it can moderately absorb the heat emitted from the heater 22. This can suppress excessive temperature changes (temperature increase or decrease) in a portion of the heater 22 corresponding to the positioning space S1.

According to the fixing device 7 of this embodiment, since the rotation regulation part 44 of the support member 26 is in contact with the side surface of the heat equalizing member 23 in the conveyance (short side direction), the rotation of the heat equalizing member 23 around the positioning member 43 can be regulated while allowing thermal expansion of the heat equalizing member 23 in both axial directions.

In the fixing device 7 of this embodiment, the thermal conductivity (λ1) of the heat equalizing member 23 is set larger than the thermal conductivity (λ2) of the support member 26, and the thermal conductivity (λ3) of the positioning member 43 is set larger than the thermal conductivity (λ1) of the heat equalizing member 23 ((λ3)≥(λ1)>(λ2)). As a result, the temperature of the fixing belt 20 can be made generally uniform over the axial direction because the positioning member 43 fitted into the positioning space S1 functions as a part of the heat equalizing member 23.

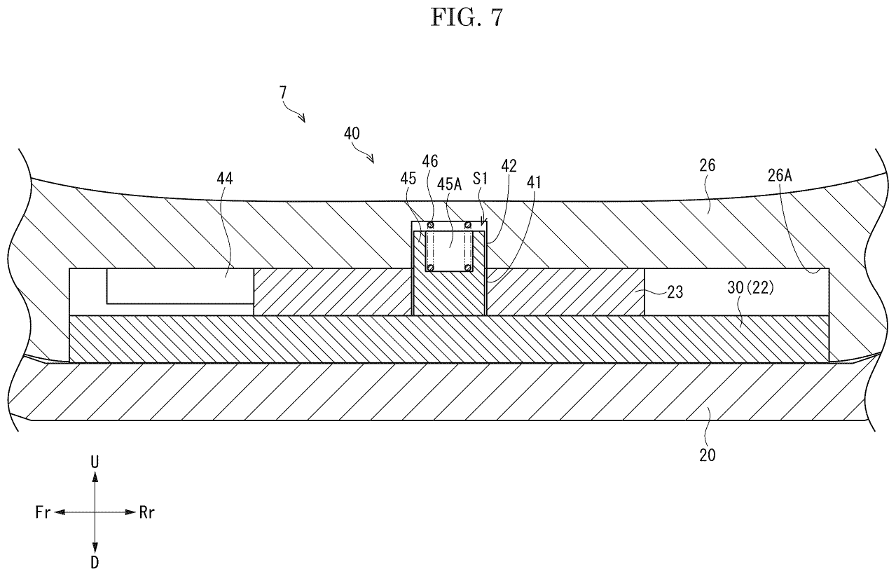

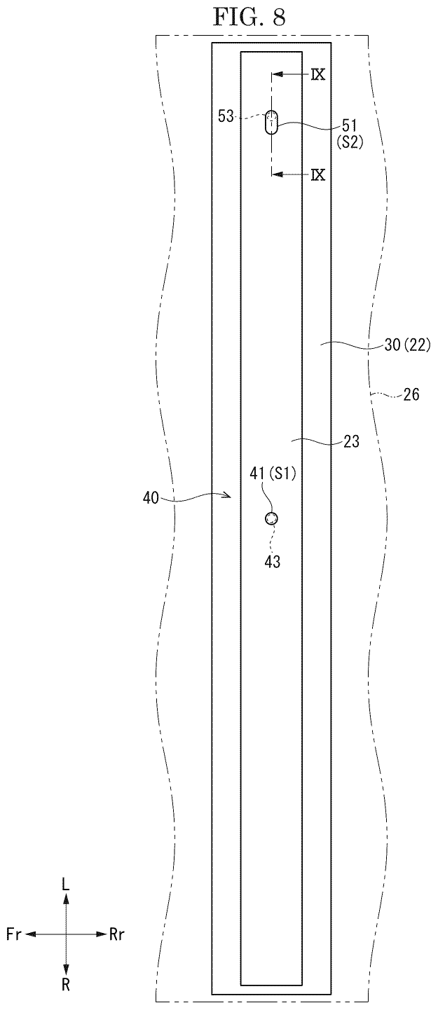

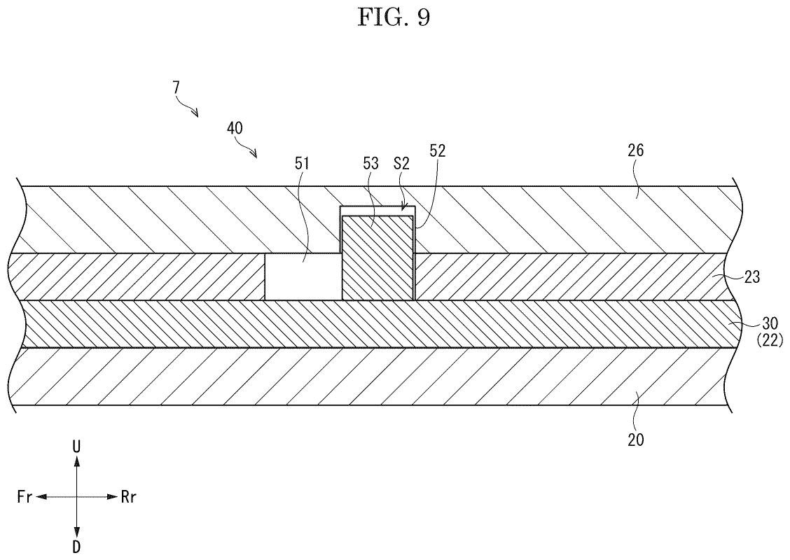

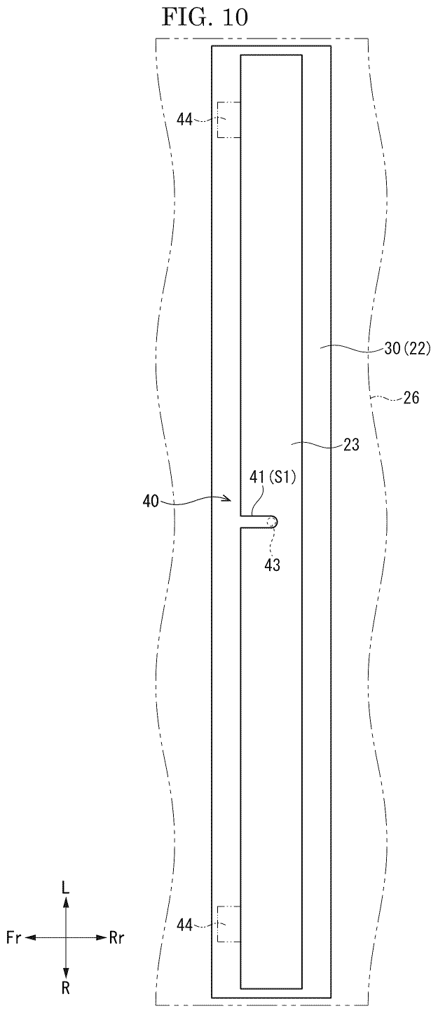

In the positioning structure 40 of the fixing device 7 of this embodiment, the two rotation regulation parts 44 are provided on the upstream side of the support member 26 in the conveyance direction, and separated in the left-and-right direction, but the present disclosure is not limited thereto. For example, the two rotation regulation parts 44 may be provided separated in the left-and-right direction on the downstream side of the support member 26 in the conveyance direction. For example, the two rotation regulation parts 44 may be provided on one side in the axial direction of the support member 26, spaced apart in the conveyance direction (the front-and-rear direction), and in contact with both the side surfaces of the heat equalizing member 23 in the conveyance direction (not shown). The rotation regulation parts 44 may be provided not only in two, but also in three or more (not shown).

[Modified Examples] Hereinafter, with reference to FIG. 7 to FIG. 10, modifies examples of the fixing device 7 of this embodiment will be described. FIG. 7 shows a cross-sectional view of the heater 22, the heat equalizing member 23, and the positioning structure 40 of the fixing device 7 according to the first modified example. FIG. 8 is a plan view showing the heater 22, the heat equalizing member 23, and the positioning structure 40 of the fixing device 7 according to the second modified example. FIG. 9 is a cross-sectional view taken along the line IX-IX of FIG. 8. FIG. 10 is a plan view showing the heater 22, the heat equalizing member 23, and the positioning structure 40 of the fixing device 7 according to the third modified example. The same symbols are attached to the components of the fixing device 7 of the above embodiment, and their descriptions are omitted.

<First Modified Example> In the fixing device 7 of the above embodiment, the positioning member 43 is held in contact with the upper surface of the heater 22 by its own weight, but the present disclosure is not limited to this. As shown in FIG. 7, in the fixing device 7 for the first modified example, the positioning member 45 is held in contact with the upper surface of the heater 22 by a biasing member 46. The biasing member 46 is, for example, a compressed coil spring, and is displaced between the support member 26 and the positioning member 45 in the positioning space S1. The fitting recess 45A is formed in the upper portion of the positioning member 45 for fitting the lower portion of the biasing member 46. The biasing member 46 presses the positioning member 45 downwardly against the upper surface (one surface) of the heater 22.

According to the fixing device 7 for the first modified example of the embodiment described above, the positioning member 45 can be kept in contact with the heater 22 because the biasing member 46 presses the positioning member 45 against the heater 22. As a result, the positioning member 45 moderately absorbs the heat of the heater 22, so that excessive temperature changes (temperature increase or decrease) in a part of the heater 22 corresponding to the positioning space S1 can be suppressed.

Since the previously described positioning member 43 is formed in a cylindrical shape thicker (higher) than the thickness of the heat equalizing member 23 (see FIG. 6), the heat capacity of the positioning member 43 is slightly larger than that of the heat equalizing member 23 of the same volume as the positioning hole 41. On the other hand, in the fixing device 7 of the first modified example, by forming the fitting recess 45A (see FIG. 7) in the upper portion of the positioning member 45, the heat capacity of the positioning member 45 is made to be approximately the same as that of the heat equalizing member 23 of the same volume as the positioning hole 41. This suppresses excessive temperature changes (temperature increase or decrease) in the vicinity of the positioning member 45, thereby suppressing temperature irregularities in the heat equalizing member 23, including the positioning member 45.

<Second Modified Example> In the fixing device 7 of this embodiment described above, two rotation regulating parts 44 are in contact with the side surface of the heat equalizing member 23 as a structure to regulate the rotation of the heat equalizing member 23, but the present disclosure is not limited to this. As shown in FIG. 8 and FIG. 9, in the fixing device 7 according to the second modified example, the structure for regulating the rotation of the heat equalizing member 23 is substantially identical to the structure (the positioning hole 41, the positioning recess 42, and the positioning member 43 (45)) for positioning the heat equalizing member 23 in the axial (long side) direction. Specifically, the positioning structure 40 includes a rotation stop hole 51, a rotation stop recess 52, and a rotation stop member 53. The rotation stop hole 51 penetrates in the thickness direction the region of the heat equalizing member 23 on one side in the axial (the left side in FIG. 8) of the heat equalizing member 23. The rotation stop recess 52 is recessed in the thickness direction at the portion of the support member 26 on one side in the axial direction, where coincides with the rotation stop hole 51. The rotation stop member 53 is disposed in a rotation stop space S2 formed by the rotation stop hole 51 and the rotation stop recess 52 in contact with the upper surface of the heater 22. The rotation stop member 53 has the same structure as the positioning member 43. The rotation stop hole 51 is a long hole formed longer in the axial direction (left-and-right direction) than the rotation stop member 53, and allows relative axial movement of the rotation stop member 53. The rotation stop recess 52 is a round hole (having a bottom) which fits the rotation stop member 53 and restricts its movement.

With the rotation stop member 53 disposed in the rotation stop space S2, the heat equalizing member 23 is restricted from rotating around the positioning member 43. When the heat equalizing member 23 thermally expands in the axial direction, the rotation stop member 53 fitted in the rotation stop recess 52 moves in the axial direction relatively within the range of the rotation stop hole 51. In this way, thermal expansion in both axial directions can be allowed while regulating the rotation of the heat equalizing member 23. At least one rotation stop hole 51 needs to be formed in at least one of both the side regions of the heat equalizing member 23 in the axial direction. For example, a pair of rotation stop holes 51 may be formed on both sides of the heat equalizing member 23 in the axial direction (not shown). Similarly, at least one rotation stop recess 52 needs be formed in the support member 26 at a position coinciding with the rotation stop hole 51, and at least one rotation stop member 53 needs to be provided according to the number of rotation stop spaces S2 formed. For example, the rotation stop hole 51 may be a round hole which restricts movement of the rotation stop member 53 and the rotation stop recess 52 may be a long hole which allows relative axial movement of the rotation stop member 53 (not shown). Both the rotation stop hole 51 and the rotation stop recess 52 may be long holes which allow relative axial movement of the rotation stop member 53 (not shown).

As in the fixing device 7 (the positioning structure 40) for the first modified example, the biasing member 46 may be disposed between the support member 26 and the rotation stop member 53 in the rotation stop space S2 and press against the upper surface (one surface) of the heater 22 (not shown). A recess may be formed in the upper portion of the rotation stop member 53 to fit the lower portion of the biasing member 46 (not shown).

In the fixing device 7 according to the present embodiment (including the first and second modified examples), the positioning holes 41 and the others are formed in the center portion of the heat equalizing member 23 and the others and the positioning member 43 is arranged in the center portion of the heat equalizing member 23 and the others. However, the present disclosure is not limited to this. For example, as shown in FIG. 10, the positioning hole 41 may be cut in an approximately U-shape from one end (front end in FIG. 10) to the center in the conveyance direction of the heat equalizing member 23 (third modified example). In this case, the positioning recess 42 is formed in the support member 26 to coincide with the positioning hole 41. Although not shown, the positioning holes 41 and the others may be formed at a position shifted in the conveyance direction from the center of the heat equalizing member 23, or may be formed at a position shifted in the axial direction from the center of the heat equalizing member 23. Thus, the positioning holes 41 and the others are not necessarily required to be formed in the center of the heat equalizing member 23 and the others, but may be formed at a position shifted from the center in the axial direction or in the conveyance direction. That is, the “central region” in the claim means a region having a certain extent of area including the center, and it is sufficient if it is possible to satisfy the condition of thermal expansion of the heat equalizing member 23 approximately equally on both sides of the axial direction.

In the fixing device 7 of this embodiment, the heat generating part 31 is divided into three resistance heating elements 32A to 32C, but it is not limited to this, and may be divided into two, four or more, or not divided (all not shown). The heat generating part 31 may also be a single resistance heating element extending from one side to the other side of the axial direction, or be a U-shaped resistance heating element that extends from one side to the other side of the axial direction and then folds back to extend from the other side to the one side of the axial direction (none shown).

In the fixing device 7 of this embodiment, the paper P passes through the center of the pressure region N in the axial direction. However, it is not limited to this, and may pass through a position closer to one side of the pressure region Nin the axial direction (not shown). In this case, the non-passing region A2 is set only on one side of the fixing belt 20 (or pressure area N) in the axial direction.

In the fixing device 7 according to the present embodiment, although the pressure roller 21 is rotationally driven to rotate and the fixing belt 20 is driven to be rotated accordingly, the fixing belt 20 may be rotationally driven to rotate and the pressure roller 21 may be rotated accordingly.

In the description of the above embodiments, the case in which the present disclosure is applied to the monochrome image forming apparatus 1 is shown as an example. However, the present disclosure may be applied to a color printer, a copying machine, a facsimile machine or a multifunctional peripheral.

The description of the above embodiments shows one aspect in the fixing device and image forming apparatus pertaining to the present disclosure, and the technical scope of the present disclosure is not limited to the above embodiments. The present disclosure may be changed, replaced, or transformed in various ways to the extent that the intent of the technical concept is not departed from, and the scope of the claims includes all possible embodiments that may be included within the scope of the technical concept.

1. A fixing device comprising:
a fixing belt which is formed in a cylindrical shape and heats toner on a medium while rotating around an axis;
a pressure member which forms a pressure region between the fixing belt and the pressure member, and pressurizes the toner on the medium passing through the pressure region while rotating around an axis;
a heater which extends in an axial direction of the axis of the fixing belt, comes into contact with an inner surface of the fixing belt in the pressure region, and heats the fixing belt;
a heat equalizing member which extends in the axial direction so as to be less than or equal to a dimension of the heater in the axial direction, comes into contact with one surface of the heater on an opposite side to the fixing belt, absorbs heat emitted from the heater and moves it in the axial direction;
a support member which comes into contact with one surface of the heat equalizing member on an opposite side to the heater, and supports the heat equalizing member; and
a positioning structure which positions the heat equalizing member with respect to the support member, wherein
the positioning structure includes:
a positioning hole penetrating in a thickness direction a center region of the heat equalizing member in the axial direction;
a positioning recess recessed in the thickness direction in a center region of the support member in the axial direction, where coincides with the positioning hole; and
a positioning member fitted into a positioning space formed by the positioning hole and the positioning recess while in contact with one surface of the heater.

2. The fixing device according to claim 1, wherein
the positioning structure further includes a biasing member provided between the support member and the positioning member within the positioning space, and
the biasing member presses the positioning member against one surface of the heater.

3. The fixing device according to claim 1, wherein
the positioning structure further includes a plurality of rotation regulation portions protruding from the support member toward the heater, and
the plurality of rotation regulation portions are in contact with a side surface of the heat equalizing member and regulates rotation of the heat equalizing member around the positioning member.

4. The fixing device according to claim 1, wherein
the positioning structure includes:
at least one rotation stop hole penetrating in a thickness direction at least one side region of both side regions of the heat equalizing member in the axial direction;
at least one rotation stop recess recessed in a thickness direction in at least one side region of both side regions of the support member in the axial direction, where coincides with the rotation stop hole; and
at least one rotation stop member disposed in a rotation stop space formed by the rotation stop hole and the rotation stop recess in contact with one surface of the heater, wherein
at least one of the rotation stop hole and the rotation stop recess is formed longer in the axial direction than the rotation stop member, and allows relative movement of the rotation stop member in the axial direction.

5. The fixing device according to claim 1, wherein
a thermal conductivity (λ1) of the heat equalizing member, a thermal conductivity (λ2) of the support member, and a thermal conductivity (λ3) of the positioning member are in the relationship (λ3)≥(λ1)>(λ2).

6. An image forming apparatus comprising the fixing device according to claim 1.
